(19) United States
(12) Patent Application Publication
(10) Pub. No.: US 2021/0262414 A1
(43) Pub. Date: Aug. 26, 2021

(54) Aircraft Drive System Having Thrust-Dependent Controller

(71) Applicant: Rolls-Royce Deutschland Ltd & Co KG, Blankenfelde-Mahlow (DE)

(72) Inventor: Johannes Wollenberg, Gräfelfing (DE)

(21) Appl. No.: 17/261,796

(22) PCT Filed: Jul. 29, 2019
(86) PCT No.: PCT/EP2019/070333

§ 371 Date: Jan. 20, 2021

(30) Foreign Application Priority Data
Jul. 31, 2018 (DE) 10 2018 212 769.7

(51) Int. Cl. F02K 3/04; F02K 5/00; G01L 5/13; B64C 11/30

(52) U.S. Cl. CPC F02K 3/04; F02K 5/00; F05D 2270/051; B64C 11/303; G01L 5/133

(57) ABSTRACT

The invention relates to a drive system for an, in particular electrically driven, aircraft. The drive system is provided with thrust measuring means which measure a currently effective thrust of the thrust generator of the aircraft. The measurement values obtained in this way are supplied to a controller of the drive system, which uses the measured thrust, along with other parameters, to control the drive system such that a selectable parameter, e.g. the thrust or an efficiency of the drive system, can be is optimised.

This application is the National Stage of International Application No. PCT/EP2019/070333, filed Jul. 29, 2019, which claims the benefit of German Patent Application No. DE 10 2018 212 769.7, filed Jul. 31, 2018. The entire contents of these documents are hereby incorporated herein by reference.

### BACKGROUND

Current motor-powered airplanes are typically driven by internal combustion engines or motors (e.g., by reciprocating or rotary piston engines, shaft turbines, or fan engines). An internal combustion engine of this kind drives a thrust generator (e.g., a propeller or a fan of a turbine etc.) that ultimately provides propulsion of the airplane. Internal combustion engines have only a narrow economical operating range with an efficient torque, rotational speed, and/or power range and have sluggish control properties. Concepts based on electric drive systems, in which electric motors are used to drive the thrust generator or generators are being investigated as alternatives to internal combustion engines.

A thrust generator of this kind may have a propeller, as in a turboprop engine, or, alternatively, a “fan”, as in a turbojet engine, where the term “propeller” will also be used below as a synonym for such a fan (e.g., will include both embodiments mentioned). A propeller typically has a multiplicity of airfoils, each of which is connected by one of its ends to a shaft and projects from the shaft in a very largely radial direction. The respective motor brings about rotation of the shaft at a predeterminable rotational speed, with the result that the airfoils rotate about the axis of rotation of the shaft and generate propulsion in the axial direction by virtue of angle of attack relative to the surrounding air. The propulsion may be varied by changing the rotational speed and/or the angle of attack of the airfoils. This concept is well known and is not explained in greater detail below.

Irrespective of the nature of the drive of the thrust generator (e.g., whether the drive is an internal combustion engine or an electric motor), the open-loop and closed-loop control of the drive or propulsion is performed by the pilot manually via “thrust levers” or by the autopilot via automatic open-loop/closed-loop thrust generator control by the “aircraft flight control” system. In this process, as already mentioned, it is the rotational speed and/or torque of the thrust generator and hence, indirectly, the thrust that are set, both in the case of manual and automatic open-loop/closed-loop control. Control parameters are flight-phase-dependent and include, for example, the speed, altitude, and rate of climb/descent of the airplane. If the airplane is supposed to climb or to fly more quickly, the rotational speed is increased (e.g., by a throttle valve or an injection control unit), and if the airplane is supposed to descend or fly more slowly, the rotational speed is reduced. This applies both to the conventional drive that has an internal combustion engine and also to airplanes driven electrically or by hybrid electric means. The use of a “constant speed propeller”, also referred to as a “variable pitch propeller”, where the open-loop/closed-loop control system varies the angle of attack of the airfoils and thus influences the thrust indirectly, allows relatively convenient open-loop/closed-loop control but is limited in the operational variation of rotational speed and airfoil angle of attack. Further, the pilot or autopilot cannot directly control the thrust produced by the thrust generator or the efficiency of the airplane but may do so only indirectly by adjusting the rotational speed and, within certain limits, by adjusting the angle of attack of the airfoils of the propeller or fan of the thrust generator.

As regards utilizing the capacity of the drive system (e.g., with respect to the maximum possible thrust or the maximum possible efficiency of the aircraft), closed-loop drive control is therefore not ideal, especially under changing operating and environmental boundary conditions. In this context, the abovementioned points apply both to airplanes (e.g., fixed-wing aircraft) and to helicopters or gyroplanes with one or more rotors. In other words, the aircraft mentioned here and below represents both fixed-wing aircraft and rotorcraft.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, better utilization of a capacity of a drive of an aircraft is provided.

The aircraft drive system of the present embodiments has at least one first and possibly further thrust generators for producing a thrust in order to provide propulsion for the aircraft. Each thrust generator includes a respective propeller and a respective motor for driving the respective propeller. Further, a respective thrust measuring device having at least one thrust measuring device for measuring the respective instantaneous thrust produced by the respective thrust generator is provided for each thrust generator. Further, a controller of the drive system is provided for the purpose of controlling the thrust of each thrust generator of the drive system. Each of the thrust measuring devices is connected to the controller in order to supply the controller with a measured value that represents the respective measured thrust, and the controller is configured to control the respective thrust as a function of the respective measured value supplied and optionally in addition as a function of other parameters.

Since both the speed and climbing power of an airplane depend primarily on the thrust of the thrust generator, the result of a thrust measurement at the thrust generator may be included in the control of the drive system. Based on this measure, it is possible to reduce or avoid errors or inaccuracies in the complex transfer functions used for drive control of an aircraft. The functions link the rotational speed and airfoil angles of attack of the thrust generator or propeller, acceleration, speed, angle of climb, altitude, etc. of the airplane, which are usually reproduced only in characteristic maps and are available in this way.

By using the directly measured thrust instead of using the effects arising from the action of the thrust (e.g., the speed, acceleration and rate of climb of the airplane) and the torque at the thrust generator shaft etc. for drive control, it is thus possible to optimize the efficiency of propulsion and energy conversion of the airplane. Suboptimal thrust levels and/or airplane efficiency levels due to suboptimal rotational speed/pitch pairings in continuously changing flying conditions may thus be reduced.

The present embodiments are therefore based on the concept of measuring the thrust of the thrust generator and of using the measured variable to control the drive system.

In one embodiment, a further thrust generator is provided in addition to the first thrust generator, where the first thrust generator is arranged on a first wing of the aircraft, and the further thrust generator is arranged on a second wing of the aircraft. The controller is configured for differential thrust control, in which the thrust instantaneously produced by the first thrust generator and the further thrust generator may be set to different values. The first wing may be arranged on the left-hand side of the fuselage, when viewed in the direction of flight. Accordingly, the second wing may be arranged on the right-hand side. The presence of two thrust generators on the two wings in combination with the possibility of differential thrust control allows banking, for example, in which the instantaneous thrust of the thrust generators is set to different values. In such a case, for example, one of the thrust generators may produce a higher thrust than the other, with the result that the aircraft flies along a corresponding curved path. The advantage is that it is possible to dispense at least partially with using the control surfaces of the rudders and ailerons, etc., which are fundamentally subject to drag. This leads to energy saving by reducing the aerodynamic drag of the aircraft.

At least one of the thrust measuring means may be configured and arranged to measure at least one deformation, occurring as a result of the respective instantaneous thrust, of at least one ultimately indirect, mechanical deformable connection of the propeller of the respective thrust generator to a body of the aircraft. The measured deformation of the connection represents the respective instantaneously produced thrust. The thrust measuring device may be a strain gage or a load cell, for example. The “body” of the aircraft includes, for example, the fuselage thereof and the wings. Here, the term “connection” may be interpreted to be that the propeller is connected or must be connected to the airplane or the body thereof at some point in order to be able to drive the airplane. The propeller is, for example, connected to the motor via the shaft, the motor is optionally arranged in a housing in a nacelle and fastened there, and this nacelle is fixed on the airplane body (e.g., on the wing thereof). Following this chain, therefore, the propeller is fixed on or connected to the airplane body indirectly (e.g., via the shaft, the motor, the housing, and the nacelle). This wording therefore does not specify at what point and precisely how the measurement of the thrust may be performed since, as specified in greater detail below, a large number of suitable points may be provided. The source of the thrust (e.g., ultimately the rotating propeller) is connected to the airplane body to be moved by the thrust. The term “deformable” may not be interpreted to be that the deformable connection is actually elastic or flexible, for example. The term “deformable” refers purely to the entirely limited deformability of an intrinsically rigid component that is unavoidable only under the typical, considerable forces applied by the thrust generator during air travel.

In one embodiment, a shaft of the respective thrust generator, which connects the respective propeller mechanically to the respective motor, forms one of the deformable connections. In this context, the respective thrust measuring device includes a thrust measuring device that is arranged on the shaft and is configured and arranged to measure a deformation of the shaft while a thrust is acting.

In another embodiment, a fixing that connects the respective motor to the body of the aircraft forms one of the deformable connections. The respective thrust measuring device then includes a thrust measuring device that is arranged on the fixing and is configured and arranged to measure a deformation of the fixing while a thrust is acting. The fixing addressed may, for example, be that the motor is fastened directly on the airplane body, which ultimately provides that a housing of the motor is fastened directly on the body since the essential components of the motor (e.g., a stator and rotor, etc.) are not fastened directly on the body. However, the fixing may also include the option specified below that the motor is arranged in a nacelle or the like, for example, and that this nacelle is fastened on the airplane body (e.g., on a wing). The deformable connection on which the thrust measuring device is to be arranged may then be the fastening of the motor in the nacelle and/or the fastening of the nacelle on the airplane body.

For example, the fixing may include at least one first and one second fixing, where the motor is fastened in a nacelle by the first fixing, and the nacelle is fastened on the body of the aircraft (e.g., on a wing of the aircraft) by the second fixing. The first fixing forms a first deformable connection, and the thrust measuring device includes a thrust measuring device that is arranged on the first fixing and is configured and arranged to measure a deformation of the first fixing while a thrust is acting. In addition, or as an alternative, the second fixing forms a second deformable connection, and the thrust measuring device includes a thrust measuring device that is arranged on the second fixing and is configured and arranged to measure a deformation of the second fixing while a thrust is acting.

For example, at least one of the thrust measuring devices may be arranged such that the at least one thrust measuring device measures a deformation that is oriented very largely parallel to the direction of action of the instantaneous thrust while the thrust is acting. Further, at least one of the thrust measuring devices may be arranged such that the at least one thrust measuring device measures a deformation that is oriented very largely perpendicularly to the direction of action of the instantaneous thrust while the thrust is acting.

In another approach to thrust measurement, at least one of the thrust measuring devices is respectively configured and arranged to measure at least one three-dimensional displacement or change in spacing of the propeller of the respective thrust generator relative to a reference (e.g., the body of the aircraft) from a rest position as a result of the instantaneous thrust, where the measured displacement represents the respective instantaneously produced thrust. The rest position is, for example, the location or position in which the respective propeller is situated when the respective propeller is not developing any thrust (e.g., when the respective propeller is not rotating). The reference is a point in the coordinate system that is fixed in space relative to the aircraft and is independent of an instantaneously acting thrust FS (e.g., the aircraft itself or the body thereof, such as a wing on which the thrust generator is arranged) or a point at which the thrust generator is connected to the body of the aircraft.

The aircraft drive system may be a conventional system having an internal combustion engine. However, it is likewise possible for the drive system to be an electric or hybrid-electric system, where the respective motor is an electric motor, to the input of which the corresponding power electronics and the required power supply are connected.

To operate an aircraft drive system of this kind having at least one thrust generator for producing a thrust in order to provide propulsion for the aircraft, in which the drive system and, for example, the thrust instantaneously produced by the drive system are controlled by a controller, an instantaneously produced thrust is measured, and the measured thrust is used to control the drive system. In the context of control, a rotational speed n of a propeller of the thrust generator and/or an angle of attack of airfoils of the propeller are set in order to set a desired thrust, for example.

As already explained, a deformation of a connection of a propeller of the thrust generator to the aircraft that occurs while a thrust is acting may be measured in order to measure the thrust. The deformation may be elongation or bending of the respective connection, for example. The connection may be the shaft via which the motor drives the propeller, for example. It is also possible for the connection to be a fixing by which the motor or a housing of the motor is fastened on the airplane, for example. It is also possible to interpret the connection such that the connection is implemented by fastening a nacelle on a wing of the aircraft, where the motor for driving the propeller is fastened in this nacelle.

The thrust may also be measured by measuring a displacement or change in spacing of a propeller of the thrust generator relative to a reference from a rest position that occurs while the thrust is acting.

In the control process, a rotational speed of the propeller and/or a respective angle of attack of airfoils of the propeller may be set such that, for each flying situation, the thrust is optimized by varying the rotational speed and/or the respective angle of attack and thus, a maximum efficiency of the drive system is achieved.

The optimization is such as to maximize either the thrust or an efficiency of the drive system, depending on the respective flying situation. The measured thrust FS may be used as the reference input variable of the controller and may be optimal in each case, taking into account the flying situation. Flying situations between which a distinction is made here are, for example, climbing (e.g., the takeoff process itself and the following flight phase for bringing the aircraft to the desired cruising altitude), cruising at a largely constant altitude and a substantially constant speed, and the landing approach plus landing.

The drive system may have a further thrust generator, for example. In this case, the controller may be configured for differential thrust control, in which the respective instantaneous thrust levels of the different thrust generators may be set to different values. In such a case, for example, one of the thrust generators may produce a higher thrust than the other, with the result that the aircraft flies along a corresponding curved path. Here, the advantage is that it is possible to dispense at least partially with using the control surfaces of the rudders and ailerons, etc., which are fundamentally subject to drag. This leads to energy saving by reducing the aerodynamic drag of the airplane 1.

Further advantages and embodiments may be found in the drawings and the corresponding description.

In the text that follows, the invention and exemplary embodiments are explained in more detail with reference to drawings. There, the same components are identified by the same reference signs in various figures. It is therefore possible that, when a second figure is being described, no detailed explanation will be given of a specific reference sign that has already been explained in relation to another, first figure. In such a case, it may be assumed for the embodiment of the second figure that, even without detailed explanation in relation to the second figure, the component identified there by this reference sign has the same properties and functionalities as explained in relation to the first figure. Further, for the sake of clarity, in some cases, not all the designations are shown in all of the figures, but only those to which reference is made in the description of the respective figure.

### BRIEF DESCRIPTION OF THE DRAWINGS

FIG. 1 shows one embodiment of an airplane having an electric drive system;

FIG. 2 shows a first variant of fastening of a thrust generator of a drive system on an airplane body;

FIG. 3 shows a second variant of fastening of the thrust generator on the airplane body;

FIG. 4 shows an illustration of one embodiment of a mode of operation of a controller of the drive system;

FIG. 5 shows a view of an airplane with two thrust generators from below.

### DETAILED DESCRIPTION

Terms such as “axial”, “radial”, “tangential”, or “in the circumferential direction”, etc. relate to the shaft or axis used in the respective figure or in the example described in each case. In other words, the directions axially, radially, tangentially always relate to an axis of rotation of the rotor. “Axial” describes a direction parallel to the axis of rotation, “radial” describes a direction orthogonal to the axis of rotation, toward or away therefrom, and “tangential” is a movement or direction orthogonal to the axis and orthogonal to the radial direction, which is thus directed at a constant radial distance from the axis of rotation and with a constant axial position in a circle around the axis of rotation. The tangential direction may optionally also be referred to as the circumferential direction.

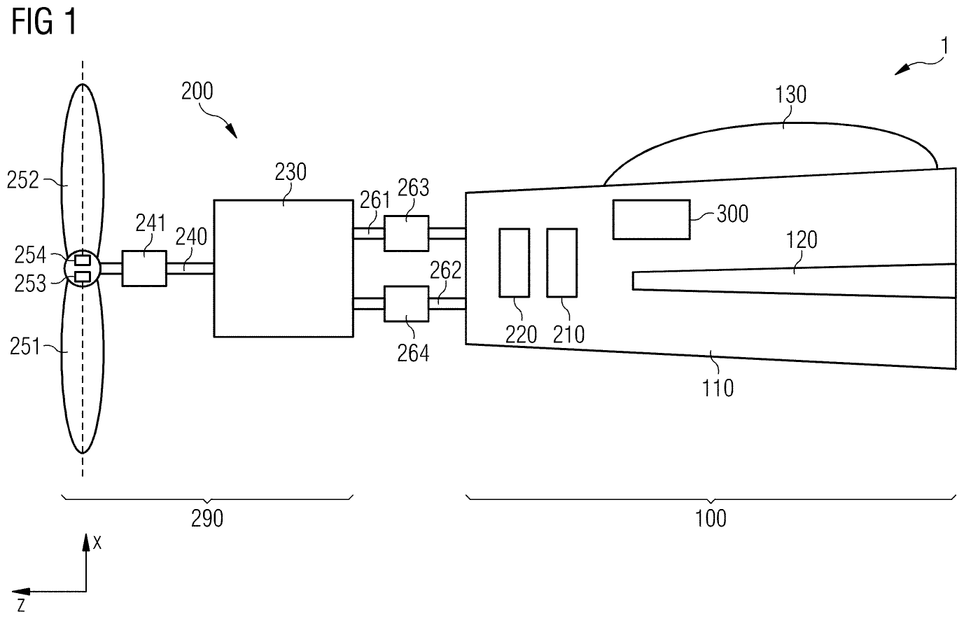

FIG. 1 shows a front part of an aircraft 1 configured as an airplane in a highly simplified illustration that is not true to scale. Only the front part of the airplane fuselage 110 with a wing 120 and a cockpit 130 are depicted. The fuselage 110, the wing 120, and the cockpit 130 as well as any further components, which are not relevant here, however, form the body 100 of the airplane 1. The body 100 also includes the other wings of the airplane 1, which, although not illustrated, are, of course, present.

Moreover, FIG. 1 shows a drive system 200 of the airplane 1. The drive system has a thrust-producing device with one or more thrust generators in order to produce propulsion for the airplane 1. For this purpose, the drive system 200 has a battery 210 and power electronics 220, where the battery 210 and the power electronics 220 are dimensioned and configured such that the battery 210 and the power electronics may supply the electric energy required to operate an electric motor 230 of the drive system 200. The electric connections between the battery 210, the power electronics 220, and the electric motor 230 are not illustrated for the sake of clarity. For its part, the electric motor 230, which is fastened on the fuselage 110 by fixings 261, 262, is connected via a shaft 240 to a propeller 250 having airfoils 251, 252 in order to set the propeller 250 in rotation and hence produce the propulsion for the airplane 1. Together, the motor 230, the shaft 240, and the propeller 250 form a thrust generator 290 of the thrust-producing device since the thrust is produced by the interplay of these components 230, 240, 250. This concept of an electrically driven airplane 1 is known per se and is therefore not explained in greater detail below.

In order to vary the thrust FS that may be produced by the propeller 250 (e.g., depending on the flying situation), it is possible for the rotational speed n of the propeller 250 to be set as desired, where a higher rotational speed n brings about an increase in the thrust FS. It is also possible for the thrust FS to be set by setting the airfoil angles of attack a(251), a(252) of the airfoils 251, 252. The airfoils 251, 252 are rotatable by corresponding actuators 253, 254 about corresponding longitudinal axes that are indicated by dashed lines and are typically oriented in the radial direction, thus enabling the respective airfoil angle of attack a(251), a(252) relative to the ambient air (e.g., the “pitch angle”) to be set for each airfoil 251, 252. Typically, but not necessarily, the pitch angles of different airfoils 251, 252 are the same. For this reason, for the sake of simplicity, no distinction is made below between the pitch angles a(251) of the first 251 and a(252) of the second airfoil 252. If the thrust FS is to be varied by adjusting the pitch angles a, this is generally a matter of automatic or semi-automatic setting by a controller 300, which essentially provides an airfoil angle of attack a that is proportional to a rotational speed and a linear speed in order to operate the motor 230 at an optimum rotational speed. This is highly relevant (e.g., in the case where, as a departure from the example illustrated in FIG. 1, the motor 230 is an internal combustion engine since an internal combustion engine of this kind, in contrast to the electric motor, cannot always be operated in the optimum rotational speed range). However, the setting of the pitch angles a of the airfoils 251, 252 by the actuators 253, 254 and of the rotational speed n of the propeller 250 may, for example, be performed independently of one another (e.g., a certain change of the rotational speed n does not mean that the angles of attack a have to be changed in a corresponding way), and may, for example, be performed in an infinitely variable manner. For setting, the actuators 253, 254 may be operated electrically, electromechanically, hydraulically, or even mechanically, for example. In general, it may be assumed that suitable actuators 253, 254 of this kind are known.

The controller 300 of the drive system 200 is thus configured to control the thrust FS of the thrust generator 290. For this purpose, the controller 300 sets certain propeller parameters (n, a) (e.g., the rotational speed n of the propeller 250 and/or the pitch angles a of the airfoils 251, 252) in order in this way to achieve the desired thrust. The settings of the pitch angles a and of the rotational speed n are generally performed independently of one another. The different effective thrust levels FS resulting from variation of the propeller parameters (n, a) also depend on ambient conditions pu (e.g., on the density of the ambient air, which is correlated with the altitude, on the instantaneous airspeed, on the instantaneous angle of climb, on any banking, on side wind, and on other flow conditions at the propeller 250).

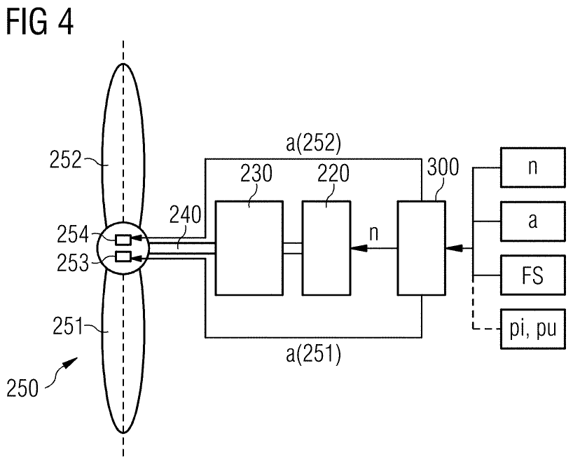

As indicated in FIG. 4, the controller 300 may process a number of parameters pi for thrust setting (e.g., an instantaneous flying situation or the flight phase), where a distinction may be made, for example, between takeoff, cruising, and landing or, more generally, between ascent and descent, a desired mission profile, flow conditions, and/or efficiency levels, etc. Further, some or all of the abovementioned ambient conditions pu may be taken into account. Moreover, an instantaneous rotational speed n of the propeller 250 and the instantaneously set pitch angles a are generally also processed.

As an additional parameter for thrust setting, the controller 300 processes, for example, the instantaneous thrust FS produced by the thrust generator 290, where this is determined in the context of a corresponding measurement. Accordingly, the measured instantaneous thrust FS is used to control the drive system 200. The controller 300 uses these parameters n, a, FS, and, where applicable, pi, pu, such that, to set the thrust FS, the controller 300 sets the rotational speed n. This is accomplished by acting in a corresponding manner on the power electronics 220 of the motor 230, with the result that the motor 230 and, together with the motor 230, the propeller 250 rotate at the desired rotational speed n. The controller 300 determines the angles of attack a(251), a(252) of the airfoils 251, 252 and thus controls the actuators 253, 254 in order to set the angles a(251), a(253).

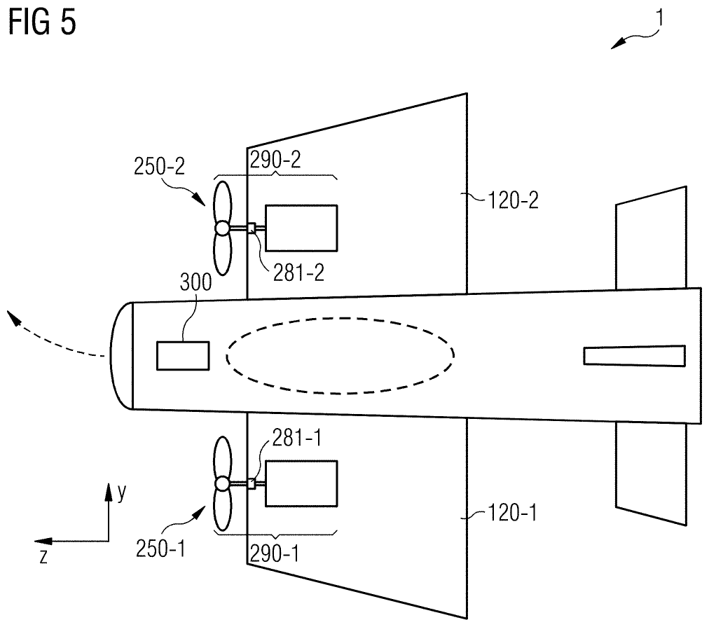

The instantaneous thrust may be measured at several different locations, where respective force detectors are mounted at suitable locations of this kind. The detectors typically producing an electric output signal that is dependent on the measured thrust FS and is fed to the controller 300 and processed further there. In principle, the thrust FS may be measured, for example, via the deformation of connections between the component producing the thrust FS (e.g., the thrust generator 290 or, in the final instance, the propeller 250 thereof) and the object to be accelerated (e.g., the airplane body 100). Such deformations are associated directly with the instantaneously acting thrust FS, thus making it possible to infer the thrust FS from the deformations. The measurement of the thrust FS by the determination of a deformation by a correspondingly designed force detector is merely one possibility for thrust measurement. Other possibilities are measurement of the spacing between the respective propeller and a reference that is defined at a fixed location on the airplane, for example. In the text that follows, however, details will be given for force measurement based on detection of deformation without this approach being regarded as a core of the invention. The alternative consisting of monitoring of spacing is explained in conjunction with FIG. 5.

One starting point for the measurement of the instantaneous thrust FS based on a deformation is, for example, the shaft 240 that connects the motor 230 to the propeller 250. For this purpose, there is a thrust measuring device or force detector 241 on the shaft 240, which may be configured as a “load cell” or as a strain gage, for example. The thrust FS produced while the propeller 250 is rotating causes a deformation of the shaft 240 dependent on the thrust FS, which typically takes the form of a substantially proportional elongation of the shaft 240, which is detected by the force detector 241. This detector produces an electric output signal that is dependent on the detected deformation and hence on the instantaneous thrust FS, and is fed to the controller 300 and processed further there.

In addition or as an alternative to measurement at the shaft 240, the thrust may be measured at fastening points of the driving machine (e.g., essentially of the motor 250) on the fuselage 110. FIG. 1 shows a possible arrangement on the nose of the airplane 1, in which the motor 250 is fastened on the front of the fuselage 110 of the airplane 1 in the direction of flight by the fixings 261, 262. At at least one of the fixings 261, 262, there is a force detector 263, 264 that, once again, may be configured as a load cell or as a strain gage, for example. In the configuration shown in FIG. 1, a respective force detector 263, 264 is provided on all the fixings 261, 262. In this embodiment too, the thrust produced by a rotating propeller 250 causes deformations of the fixings 261, 262, which typically take the form of substantially proportional elongations of the fixings 261, 262 that are detected by the force detectors 263, 264. These, in turn, produce corresponding electric output signals that represent the instantaneous thrust FS and are fed to the controller 300.

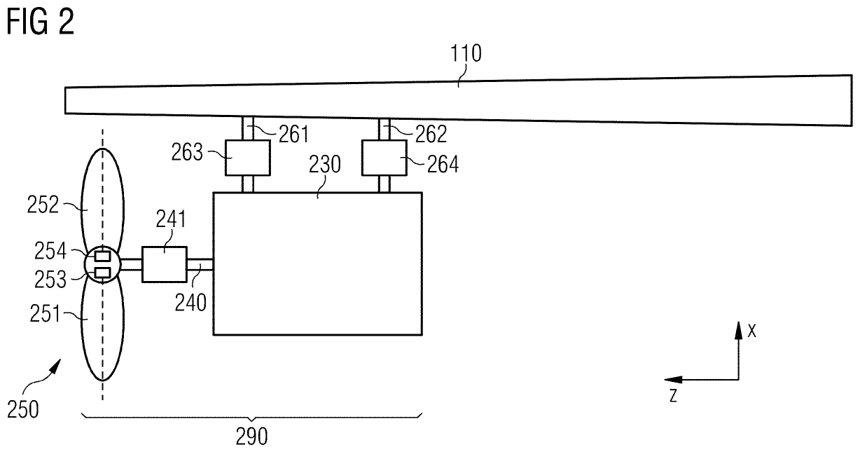

FIG. 2 shows an alternative arrangement of the thrust generator 290, where an illustration of the fuselage 110 is omitted in FIG. 2, and only the wing 120 is indicated. In this case, the thrust generator 290 is arranged on the wing 120. The motor 230 is once again fastened on the wing 120 by fixings 261, 262. Here too, a thrust produced by the rotating propeller 250 causes a deformation of the shaft 240 and of the fixings 261, 262 and of the force detectors 241 and 263, 264, respectively, that may be arranged there. It may typically be assumed that the deformations and hence the output signals of the force detectors 241, 263, 264 are very largely proportional to the thrust.

The kind of deformation of the respective force detector/s 241 and 263, 264 respectively depends on the arrangement and alignment thereof in relation to the direction of action of the thrust. The thrust typically acts in the direction of flight z (e.g., in the case of the force detectors 241, 263, 264 illustrated in FIG. 1 and in the case of the force detector 241 illustrated in FIG. 2, the deformation takes the form of an elongation of the force detector 241, 263, 264 along the z axis of the indicated coordinate system). In contrast, the force detectors 263, 264 illustrated in FIG. 2 are arranged such that the thrust does not cause any elongation but causes bending of the force detectors substantially around the y axis, which is oriented perpendicularly to the illustrated x and z axes, with the result that the effective force is determined by way of the bending deformation.

Even if, in FIG. 2, only the thrust generator 290 under the wing 120 is illustrated and described, it may be assumed that a corresponding and typically same thrust generator (e.g., a further thrust generator) is situated under the second wing (not illustrated) of the airplane 1. The further thrust generator operates in the same way as the thrust generator 290 illustrated in FIG. 2 and is likewise equipped with devices that correspond to the devices 241 and/or 263, 264 for measuring the thrust produced by the further thrust generator. Such an architecture is indicated in FIG. 5.

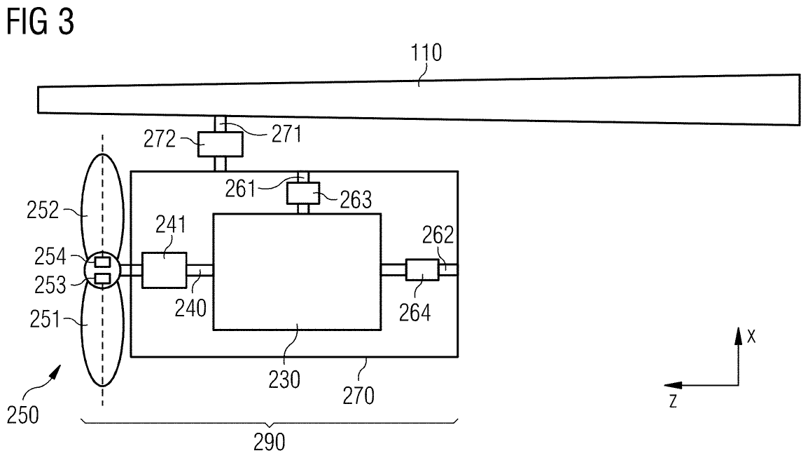

FIG. 3 shows an embodiment that largely corresponds to the embodiment in FIG. 2 in a highly simplified illustration. In contrast to FIG. 2, this illustrates that the motor 250 is arranged in a housing 270 or in a nacelle 270 that is fastened on the wing 120 by a fixing 271. The motor 250 is fastened in the nacelle 270 by fixings 261, 262. One or more of the fixings 261, 262, 271 and optionally also, as already described, the shaft 240 may be equipped with a force detector 263, 264, 272, 241. FIG. 3 illustrates that a respective force detector 263, 264, 272, 241 is provided for each of the stated fixings 261, 262, 271 and also for the shaft 240. This is not absolutely necessary but would have the advantage that there would be a corresponding large number of measured values, making it possible to assume higher accuracy and/or redundancy in the sense of higher reliability of thrust measurement. In the illustrative embodiment illustrated in FIG. 3 too, a thrust produced by the rotating propeller 250 causes a deformation of the fixings 261, 262, 271 and of the shaft 240 that is dependent on the thrust, with the result that the force detectors 263, 264, 272, 241 that are optionally mounted there produce a respective corresponding electric signal that, in turn, is fed to the controller 300.

With respect to FIGS. 1-3, in reality, not only one or two fixings 261, 262, 271 but a multiplicity of fixings are provided for the fastening of a respective component (e.g., for the motor 250 or for the nacelle 270, etc.) on another component (e.g., on the fuselage 110 or on the wing 120, etc.). However, this has not been illustrated for the sake of clarity. All that is important is that a force detector is arranged on at least one respective fixing of this kind in order to measure the deformations of the respective fixing due to the thrust. Accordingly, this relates especially to those fixings that, in the presence of a thrust, are subject to a deformation directly dependent on the thrust.

As explained above, the controller 300 may process a multiplicity of further parameters pi for thrust setting in addition to the thrust FS itself measured in this way. These further parameters pi are determined or made available by approaches known per se and are therefore not explained in greater detail at this point.

The controller 300 processes the multiplicity of parameters, including the measured instantaneous thrust FS, such that the rotational speed n of the propeller 250 and the pitch angles a of the airfoils 251, 252, which affect the thrust, are set such that, for each flying situation, the thrust is optimized by varying the rotational speed n and pitch a. The maximum efficiency is thus achieved. In this case, optimizations may be aimed, for example, at maximizing either the thrust or, alternatively, the drive efficiency, depending on the respective flying situation, for example. The measured thrust FS may be used as the reference input variable of the controller and may be optimal in each case, taking into account the flying situation.

If, for example, the flying situation requires the maximum possible available thrust FS (e.g., the optimum as regards the interaction between the propeller 250 and the electric drive), the rotational speed n and the angle of attack a may be controlled such that the maximum possible thrust that the thrust generator 290 may make available is generated.

If the flying situation requires energy-efficient cruising, for example, the rotational speed n and angles of attack a may be controlled such that the maximum thrust FS is generated at, in each case, the minimum possible driving power of the electric drive, resulting in a maximum efficiency of the drive 200. In the cases mentioned, the “electric drive” is represented essentially by the electric motor 230, even if, strictly speaking, the power electronics 220 may be included in the electric drive.

Depending on the desired optimization, the controller 300 will set a suitable combination of rotational speed n and the pitch angle a, and, in doing so, will take account particularly of the instantaneous measured thrust as an input parameter.

By the continuous measurement and control of the thrust at the thrust generator 290, which is used to set the rotational speed n and the angle of attack a of the airfoils, it is possible in this way to optimize the flying characteristics in various flying situations.

For takeoff, climbing, or in extreme or emergency situations, for example, the system may be adjusted to the maximum possible thrust FS. In this process, automatic setting of the instantaneous maximum possible thrust FS is performed, followed by continuous readjustment to the maximum possible thrust FS with suitable controller hardware and software. This includes continuous determination and setting of a respective optimum operating point (e.g., continuous intelligent adjustment of the rotational speed n and angles of attack a, as well as checking with respect to the best possible operating point of the drive system 200) taking into account the current flying situation. Once the optimum operating point has been found, the system may retain the settings under the same boundary conditions. If the boundary conditions change (e.g., if there is a different flying situation), a new optimum operating point is to be determined and ultimately set.

In the case of a drive system 200 based on an electric motor 200, it is possible to adjust to a maximum possible energy efficiency of the airplane 1 (e.g., for use in cruising) by additionally including the instantaneously supplied voltage and the associated current of the electric power supply 210 in the control of the drive system 200. A corresponding result is possible, when using a drive system based on an internal combustion engine instead of the electric drive, by taking instantaneous fuel consumption into account. In both cases, an extension of the range of the airplane 1 would thus be among the achievable outcomes. The controller 300 would set the energy efficiency optimum for the airplane and then readjust continuously to the maximum possible energy efficiency using suitable control hardware and software, the procedure once again being that already described above.

In another application, in which the controller 300 also processes noise emission values, such noise emissions may be reduced. For this purpose, the instantaneously possible noise emission minimum of the thrust generator is first of all set. Using suitable controller hardware and software, the system is then readjusted continuously to minimum possible noise emissions of the thrust generator 290.

For the case indicated in FIG. 5, in which the airplane 1 has more than one thrust generator 290-1, 290-2 (e.g., in each case one such thrust generator 290-1, 290-2 on each of the two wings 120-1, 120-2 of the airplane 1), aerodynamically efficient airplane control becomes possible. Each of the two thrust generators 290-1, 290-2 operates in the same way as the thrust generator 290 described above, and the controller 300 does not ultimately differ from the controller 300 described above (e.g., respect to taking into account the instantaneous thrust FS in controlling the drive). The presence of two thrust generators 290-1, 290-2 on the two wings 120-1, 120-2 allows differential thrust control of the two thrust generators 290-1, 290-2 for banking, for example, in which the instantaneous thrust levels FS-1, FS-2 of the thrust generators 290-1, 290-2 are optionally set to different values. In such a case, for example, one of the thrust generators 290-1 may produce a higher thrust FS-1 than the other 290-2, with the result that the airplane 1 flies along a corresponding curved path, as indicated by the dashed line. Here, the advantage is that it is possible to dispense at least partially with using the control surfaces of the rudders and ailerons, etc., which are fundamentally subject to drag. This leads to energy saving by reducing the aerodynamic drag of the airplane 1.

The thrust measuring devices or force detectors 241, 263, 264, 272 introduced thus far in the context of the description of the figures are based on determining a deformation (e.g., by strain gages). This specific method of force measurement by detection of a deformation is merely one example. Other approaches to force measurement may be provided and may accordingly also be used for the use presented here. To make this clear, FIG. 5 illustrates a force detector 281 that, in contrast to the force detectors 241, 263, 264, 272 presented hitherto, is not necessarily mounted at a location in which there is a deformation of a fixing or the like in the sense explained above in the presence of a thrust FS. Accordingly, this force detector 281 is also not configured as a strain gage or load cell. In the design indicated here, the respective force detector or thrust measuring device 281-1, 281-2 detects a displacement of the propeller 250-1 or 250-2 relative to a reference from a rest position or a corresponding change in spacing between the reference and the propeller 250-1 or 250-2, where the displacement once again occurs owing to an instantaneously acting thrust FS. The rest position is the location or position in which the respective propeller 250-1 or 250-2 is situated when the respective propeller 250-1 or 250-2 is not developing any thrust (e.g., when the respective propeller 250-1 or 250-2 is not rotating). The reference is a point in the coordinate system that is fixed in space relative to the airplane 1 and is independent of an instantaneously acting thrust FS (e.g., the airplane 1 itself or the body 100 thereof). For example, the force detector 281-1 is mounted in a fixed manner on the wing 120-1 (e.g., the reference for the force detector 281-1 may be the fastening point of the force detector 281-1 on the wing 120-1). A corresponding statement would apply to the other force detector 281-2. The only relevant point is that the position of a respective reference remains unchanged relative to the airplane 1, even at an instantaneous thrust FS≠0.

Stated more simply, the thrust measuring devices 281-1, 281-2 may be configured such that the thrust measuring devices 281-1, 281-2 each measure the spacing between the respective thrust measuring device 281-1, 281-2 and the propeller 250-1, 250-2 associated with the respective thrust measuring device 281-1, 281-2. The respective spacing typically becomes greater when the thrust FS is increased, and therefore, the measured spacing is in each case a clear measure of the instantaneous thrust FS.

The airplane 1 described in conjunction with FIG. 1 has a purely electric drive system 200. The present embodiments explained here may also be applied to other drive concepts. For example, the present embodiments may be applied to a hybrid-electric drive system or, alternatively, to a conventional drive system, which typically has an internal combustion engine or a turbine. In the case of a drive system of some other design too, a propeller is set in rotation by a motor in order to produce thrust and hence propulsion (e.g., the architecture of the components relevant to the invention explained here is no different). In these cases too, the thrust is measured directly at one or more points, and the respective result of measurement is then used, as described, to make optimum use of the capacity of the drive system 200.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An aircraft drive system comprising:
a thrust-producing device operable to provide a thrust, such that propulsion for the aircraft is provided, the thrust-producing device comprising:
at least one first thrust generator, wherein each thrust generator of the at least one first thrust generator of the thrust-producing device has a respective propeller and a respective motor for driving the respective propeller; and
at least one respective thrust measuring device for measuring the respective instantaneous thrust produced by the respective thrust generator for each thrust generator.

2. The aircraft drive system of claim 1, further comprising a controller configured to control the thrust of each thrust generator of the thrust-producing device,
wherein, for each thrust generator;
the at least one respective thrust measuring device is connected to the controller, such that the controller is supplied with a measured value that represents the respective measured thrust; and
the controller is configured to control the respective thrust as a function of the respective measured value supplied.

3. The aircraft drive system of claim 2, wherein the thrust-producing device further comprises a second thrust generator,
wherein the at least one first thrust generator is arranged on a first wing of the aircraft, and the second thrust generator is arranged on a second wing of the aircraft, and
wherein the controller is further configured for differential thrust control, in which the thrust instantaneously produced by the at least one first thrust generator and the second thrust generator is settable to different values.

4. The aircraft drive system of claim 1, wherein one or more thrust measuring devices of the at least one thrust measuring device are, in each case, configured and arranged to measure at least one deformation, occurring as a result of the respective instantaneous thrust, of at least one deformable connection of the propeller (250) of the respective thrust generator to a body of the aircraft and,
wherein the measured deformation of the connection represents the respective instantaneously produced thrust.

5. The aircraft drive system of claim 4, wherein the respective thrust generator has a shaft that connects the respective propeller to the respective motor,
wherein the shaft forms one of the deformable connections, and
wherein the respective thrust measuring device is arranged on the shaft and is configured to measure a deformation of the shaft while a thrust is acting.

6. The aircraft drive system of claim 4, wherein the respective motor is connected via a fixing to the body of the aircraft,
wherein the fixing forms one of the deformable connections, and
wherein the respective thrust measuring device is arranged on the fixing and is configured to measure a deformation of the fixing while a thrust is acting.

7. The aircraft drive system of claim 1, wherein a respective thrust measuring device is a strain gage or a load cell.

8. The aircraft drive system of claim 1, wherein one or more of the thrust measuring devices are, in each case, configured and arranged to measure at least one three-dimensional displacement, occurring as a result of the instantaneous thrust, of the propeller of the respective thrust generator relative to a reference, and
wherein the measured deformation represents the respective instantaneously produced thrust.

9. The aircraft drive system of claim 1, wherein the motor of the respective thrust generator is an electric motor.

10. A method for operating an aircraft drive system having a thrust-producing device for producing a thrust in order to provide propulsion for the aircraft, wherein the thrust-producing device has at least one first thrust generator, wherein the aircraft drive system is controlled by a controller, the method comprising:
measuring an instantaneously produced thrust; and
controlling the aircraft drive system using the measured thrust.

11. The method of claim 10, wherein measuring the instantaneously produced thrust comprises measuring a deformation of a connection of a propeller of the at least one first thrust generator to the aircraft.

12. The method of claim 10, wherein measuring the instantaneously produced thrust comprises measuring a displacement of a propeller of the at least one first thrust generator relative to a reference.

13. The method of claim 10, wherein controlling the aircraft drive system comprises setting, in a control process, a rotational speed of the propeller, a respective angle of attack of airfoils of the propeller, or the rotational speed and the respective angle of attack such that the thrust is optimized for each flying situation by varying the rotational speed, the respective angle of attack, or the rotational speed and the respective angle of attack.

14. The method of claim 13, wherein the optimization maximizes the thrust or an efficiency of the aircraft drive system, depending on the respective flying situation.

15. The method of claim 10, wherein the thrust-producing device has a second thrust generator, and
wherein controlling the aircraft drive system comprises setting, with differential thrust control by the controller, the respective instantaneous thrust of the different thrust generators to different values.
